(19) United States
(12) Patent Application Publication
(10) Pub. No.: US 2005/0176376 A1
(43) Pub. Date: Aug. 11, 2005

(54) Batch testing system and method for wireless communication devices

(75) Inventor: I-Ru Liu, Taipei (TW)

Correspondence Address: BRUCE H. TROXELL, SUITE 1404, 5205 LEESBURG PIKE, FALLS CHURCH, VA, 22041, US

(73) Assignee: Accton Technology Corporation

(21) Appl. No.: 10/775,197

(22) Filed: Feb. 11, 2004

(51) Int. Cl. H04M 1/00

(52) U.S. Cl. 455/67.16; 455/67.11

(57) ABSTRACT

The present invention provides a batch testing system and method that applies a single shielded anechoic chamber to simultaneously test multiple wireless communication devices. The shielded anechoic chamber can avoid external electromagnetic interference, reduce strength of reflected signals significantly and provide stable channel environment, thereby testing signal transceiving of the wireless communication devices more precisely. The present invention also provides a design for the batch container and loading mechanism within the chamber.

### BACKGROUND OF THE INVENTION

(a). Field of the Invention

The present invention relates in general to a batch testing system and method for wireless communication devices, and more particularly to a system and method that tests multiple wireless communication devices simultaneously within a shielded anechoic chamber.

(b). Description of the Prior Arts

In recent years, cellular phones and wireless local area networks (WLAN) are in widespread use with the rapid development of wireless communication technologies. For manufacturers of wireless products such as cellular phones, wireless network interface cards, wireless access points, etc., signal transceiving of the products is mostly tested in shielded anechoic chambers. However, the conventional testing method only installs and tests a product in the chamber at a time. When a lot of products are tested, much time would be spent in the installation of devices under test (DUTs), and other devices are idle other than the DUT. Therefore, the conventional testing method lacks efficiency. If we want to perform a batch test, i.e. to test multiple devices simultaneously, then multiple shielded anechoic chambers are required for testing. But, this would increase testing cost, such as the cost of instruments and labor powers. Hence, for the manufacturers who need to test a large number of wireless products rapidly and inexpensively, the conventional method for batch testing is very short of efficiency.

Another conventional method for batch testing is implemented in the cable mode. FIG. 1 is a block diagram showing a cable mode architecture for batch testing of wireless communication devices. In FIG. 1, the cable mode architecture includes a 2-to-N switch 13 for guiding the flow of testing signals, and N DUTs 14 coupled to the switch 13 and a control unit 15. The control unit 15 controls which of the N DUTs 14 to receive/transmit signals. The cable-mode architecture also includes a signal generator 11 and a signal monitor 12. The signal generator 11 can generate testing signals, which are delivered via the switch 13 to the DUT 14 selected by the control unit 15. The signal monitor 12 receives testing signals, via the switch 13, from the DUT 14 selected by the control unit 15. Although a batch test of the DUTs 14 can be performed by applying the architecture of FIG. 1, testing of the antenna of the DUT 14 is bypassed since the architecture adopts the cable mode to simulate the signal transceiving. Therefore, this conventional method for batch testing cannot provide a full and reliable testing report for wireless products.

In view of this, the present invention provides a batch testing system and method that can avoid the drawbacks of the cable mode, and also test multiple wireless communication devices simultaneously with low cost to upgrade testing efficiency.

### SUMMARY OF THE INVENTION

The present invention employs a single shielded anechoic chamber to perform batch testing of wireless communication devices. Besides external electromagnetic interference (EMI), the shielded anechoic chamber can also avoid superfluous reflection paths during testing. This is contributed to inner walls of the chamber with particular material, which can absorb most energy of the incident signal upon the inner walls and reduce strength of the reflected signal significantly. Thus, the shielded anechoic chamber can avoid signal instability resulted from the multi-path effect. The present invention also provides a design of the batch container and installation mechanism within the shielded anechoic chamber, thereby facilitating the batch testing of wireless communication devices to upgrade testing performance.

Accordingly, an object of the present invention is to provide a batch testing system for wireless communication devices. The batch testing system includes: a signal generator for generating a first testing signal; a transceiving unit, set in a shielded anechoic chamber and coupled to the signal generator, for transmitting the first testing signal; a plurality of wireless communication devices under test (DUTs) in the shielded anechoic chamber, wherein the wireless communication devices receive the first testing signal from the transceiving unit, and transmit a plurality of second testing signals to the transceiving unit; and a signal monitor, coupled to the transceiving unit, for monitoring the second testing signals received by the transceiving unit. A batch container, which sets the DUTs, is installed into the shielded anechoic chamber by means of a window-type or drawer-type mechanism.

Another object of the present invention is to provide a batch testing method for wireless communication devices. The batch testing method includes: setting a plurality of wireless communication devices in a shielded anechoic chamber; generating a first testing signal; transmitting the first testing signal by a transceiving unit; receiving the first testing signal by the wireless communication devices; analyzing the received first testing signal; transmitting a plurality of second testing signals by the wireless communication devices; receiving the second testing signals by the transceiving unit; and monitoring the received second testing signals.

The present invention also provides another batch testing method for wireless communication devices, which includes: setting a plurality of wireless communication devices in a shielded anechoic chamber; selecting a transmitting group and a receiving group of wireless communication devices from the plurality of wireless communication devices; transmitting at least a testing signal by the transmitting group; receiving the testing signal by the receiving group; and analyzing the testing signal received by the receiving group.

### BRIEF DESCRIPTION OF THE DRAWINGS

FIG. 1 is a block diagram showing a conventional cable mode architecture for batch testing of wireless communication devices.

FIG. 2 is a schematic view showing a preferred embodiment of the batch testing system according to the present invention.

FIG. 3 is a diagram illustrating operation of the circular batch container in the shielded anechoic chamber.

FIG. 4A is a diagram showing a window-type loading mechanism of a preferred embodiment.

FIG. 4B is a diagram showing a drawer-type loading mechanism of another preferred embodiment.

FIG. 5 is a flow chart showing a preferred embodiment of the batch testing method according to the present invention.

FIG. 6 is a flow chart showing another preferred embodiment of the batch testing method according to the present invention.

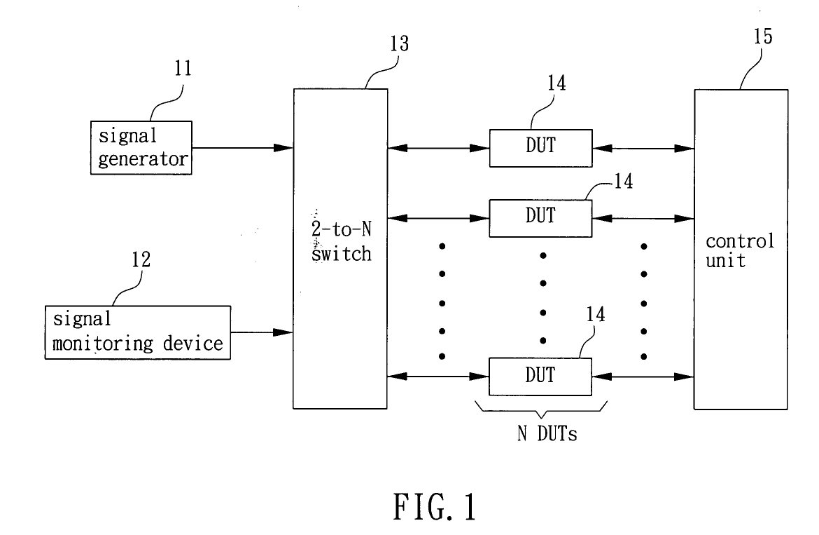

### DETAILED DESCRIPTION OF THE PRESENT INVENTION

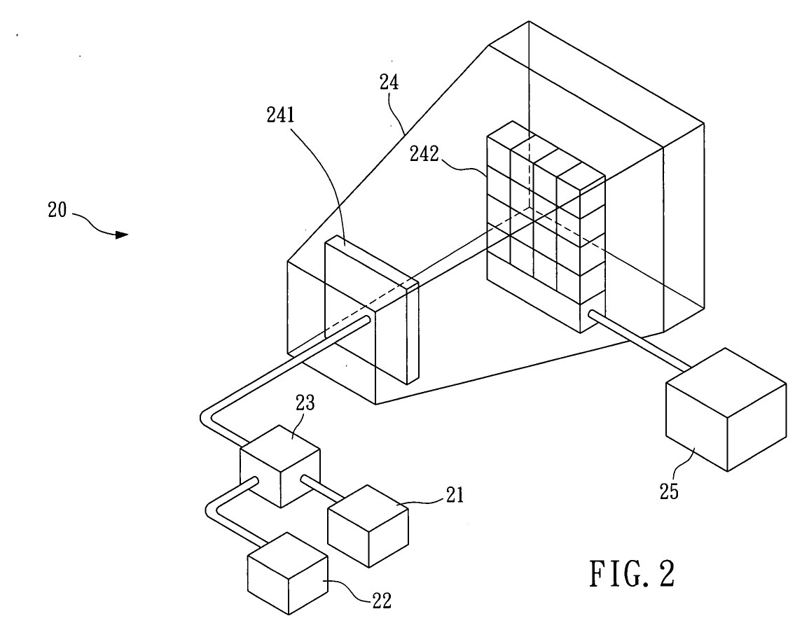

This section will explain the present invention in detail with preferred embodiments and appended drawings. FIG. 2 is a schematic view showing a preferred embodiment of the batch testing system according to the present invention. In FIG. 2, the batch testing system 20 is used to test a plurality of wireless communication devices, such as wireless network interface cards, wireless access points, wireless communicators, etc. The batch testing system 20 includes a signal generator 21 for generating a first testing signal. To obtain better testing performance, a Golden Sample of the wireless communication device under test (DUT) can be used as the signal generator 21. The Golden Sample conforms to associated standards and specifications much closer than the DUT, thus its signal quality is better for testing. Besides, a vector signal generator, or combined with a power amplifier, can also be used as the signal generator 21 to generate signals.

The batch testing system 20 also includes a shielded anechoic chamber 24, which is used to isolate external EMI and lower the reflection effects resulted from the signal propagation therein. A transceiving unit 241, coupled to the signal generator 21, is set within the shielded anechoic chamber 24. The transceiving unit 241 contains an antenna or antenna array for transmitting the first testing signal from the signal generator 21. The DUTs receive the first testing signal transmitted by the transceiving unit 241, and transmit a plurality of second testing signals to the transceiving unit 241. In the embodiment of FIG. 2, the shielded anechoic chamber 24 is a pyramid or tapered anechoic chamber and the transceiving unfit 241 is set at the top thereof. In this way, a larger quiet zone than that of the common cubical chamber is obtained. The quiet zone is formed due to the characteristics of the chamber 24. The first testing signal is transmitted mainly in the direct path from the transceiving unit 241 to the DUTs (i.e. the path without reflection), while reflected portions of the first testing signal in the indirect paths are lowered significantly in the quiet zone. Setting the DUTs in the quiet zone would bring better testing results.

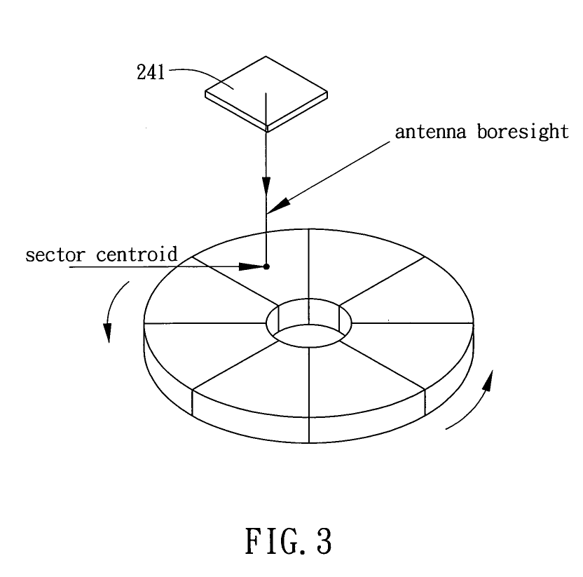

The batch testing system 20 also includes a batch container 242 for setting the DUTs. In the embodiment of FIG. 2, the batch container 242 is a rectangular container with grid partitions for setting the DUTs. The boresight of the antenna of the transceiving unit 241 is kept focusing on the center of the rectangular batch container 242. In another embodiment, the batch container 242 is a circular container with sector partitions for setting the devices, as shown in FIG. 3. The antenna bore sight of the transceiving unit 241 is kept focusing on the center of the circular batch container 242, or the centroid of a sector. In the latter case, after the DUT within a sector is tested, the circular batch container 242 is rotated and the antenna boresight is focused on the centroid of next sector for testing.

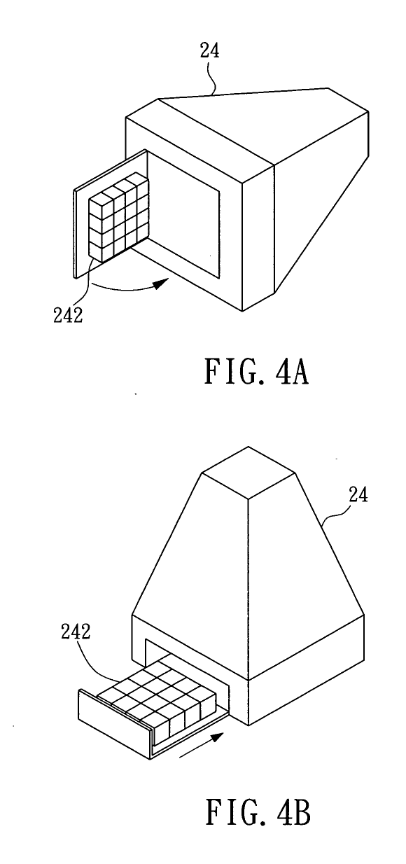

The batch testing system 20 provides mechanisms for installing the DUTs, as shown in FIG. 4A and 48. FIG. 4A is a diagram showing that the batch container 242 is set into the shielded anechoic chamber 24 by a window-type loading mechanism. FIG. 413 is a diagram showing that the batch container 242 is set into the shielded anechoic chamber 24 by a drawer-type loading mechanism. By using the above mechanisms, multiple DUTs can be rapidly installed.

In FIG. 2, the batch testing system 20 also includes a signal monitoring device 22, coupled to the transceiving unit 241, for monitoring the second testing signals received by the transceiving unit 241. According to requirements of various testing items, the signal monitoring device 22 may include various instruments, such as a vector signal analyzer and power meter, or a spectrum analyzer. Besides, the Golden Sample of the DUT may also be used as the signal monitoring device 22.

The batch testing system 20 couples a control unit 25, such as a personal computer or work station, to the signal generator 21, the signal monitoring device 22 and the DUTs, thereby controlling generation of the first testing signal and monitoring and transmission of the second testing signals. The control unit 25 can also execute related analysis software to analyze testing signals. In the above embodiment using the circular batch container, the control unit 25 is further coupled to the circular batch container to control the rotation angle.

The batch testing system 20 also couples a multiplexer 23 to the control unit 25, and the signal generator 21 and signal monitoring device 22 are coupled to the transceiving unit 241 respectively via the multiplexer 23, as shown in FIG. 2. Under the control of the control unit 25, the multiplexer 23 can be switched between the signal generator 21 and signal monitoring device 22, or between various signal-generating units within the signal generator 21, or between various signal-monitoring units within the signal monitoring device 22.

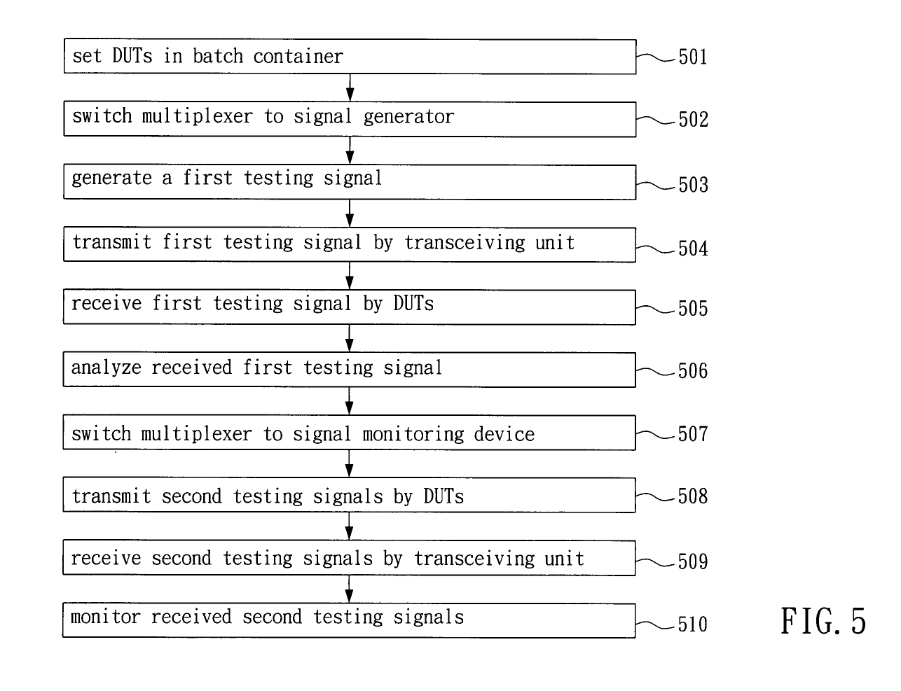

Next, it would be explained how to utilize the system 20 to implement the batch testing method of the present invention. FIG. 5 is a flow chart showing a preferred embodiment of the batch testing method according to the present invention. As shown in FIG. 5, the flow chart comprises steps of:
501 setting a plurality of DUTs in the batch container 242 of the shielded anechoic chamber 24;
502 switching the multiplexer 23 to the signal generator 21;
503 generating a first testing signal by the signal generator 21;
504 transmitting the first testing signal by the transceiving unit 241;
505 receiving the first testing signal by the DUTs;
506 analyzing the received first testing signal by the control unit 25;
507 switching the multiplexer 23 to the signal monitoring device 22;
508 transmitting a plurality of second testing signals by the DUTs;
509 receiving the second testing signals by the transceiving unit 241; and
510 monitoring the received second testing signals by the signal monitoring device 22.

In the step 501, the DUTs can be installed by means of the mechanisms shown in FIGS. 4A and 4B. Preferably, the batch container 242 is deployed within the quiet zone of the shielded anechoic chamber 24.

The steps 502 to 506 are used to test the receiver of the DUT. In these steps, the multiplexer is switched to the signal generator 21, and then the first testing signal generated by the signal generator 21 can be transmitted within the chamber 24 by the transceiving unit 241. Next, the transmitted first testing signal is received by the receiver of the DUT for subsequent analysis. As mentioned above, the signal generator 21 can be a vector signal generator or a Golden Sample of the DUT.

In the step 505, the first testing signal is received in a predetermined channel by all DUTs simultaneously. Then, in the step 506, the control unit 25 analyzes the received first testing signal for each DUT respectively by a proper method, such as performing signal quality analysis software, thereby measuring the minimum input power and packet error rate (PER) of the receiver of each DUT in the predetermined channel. In another preferred embodiment, the first testing signal is received in a predetermined channel by each DUT in turn in the step 505. Then, in the step 506, the control unit 25 analyzes the received first testing signal for each DUT by a proper method, such as performing link quality analysis software, thereby measuring the downlink throughput of the receiver of each DUT in the predetermined channel.

The steps 507 to 510 are used to test the transmitter of the DUT. In these steps, the multiplexer is switched to the signal monitoring device 22, and then the second testing signal transmitted by the transmitter of the DUT can be received within the chamber 24 by the transceiving unit 241. Next, the received second testing signal is delivered to the signal monitoring device 22 for subsequent analysis. As mentioned above, the signal monitoring device 22 is selected according to various testing items. If the maximum output power and error vector magnitude (EVM) of the transmitter of the DUT are tested, then a Golden Sample of the DUT or a vector signal analyzer with a power meter is used as the signal monitoring device 22. In the step 508, the second testing signal is transmitted in a predetermined channel by each DUT in turn. Then, in the step 510, the signal monitoring device 22 monitors the received second testing signal for each DUT, thereby measuring the maximum output power and EVM of the transmitter of each DUT in the predetermined channel. Besides, the uplink throughput of the transmitter of each DUT in the predetermined channel can also be measured in the step 510.

In another case, if the center frequency and power mask of the transmitter of the DUT are tested, then a spectrum analyzer is used as the signal monitoring device 22. In the step 508, a plurality of DUTs are selected to transmit the second testing signals in a plurality of predetermined non-overlapping channels. For example, if the DUTs are WLAN products, then two of them can be selected to transmit the second testing signals in the first and eighth channels (or the second and ninth channels . . . and so on) respectively. The frequencies of both channels are separated apart, thus interference may not occur in the spectrum while testing both channels simultaneously, and the testing efficiency can then be upgraded. Then, in the step 510, a spectrum analyzer is used to monitor the second testing signals received by the transceiving unit 241, thereby measuring the center frequency and power mask of the transmitter of the selected DUTs in the non-overlapping channels.

Therefore, testing data of multiple DUTs about signal transceiving can be rapidly collected by the batch testing method of the present invention, and the testing efficiency can be upgraded significantly. Further, by repeating the steps 502 to 510 for other channels, we can know the quality and ability of signal transceiving of the DUTs within the whole spectrum specified by the related specification.

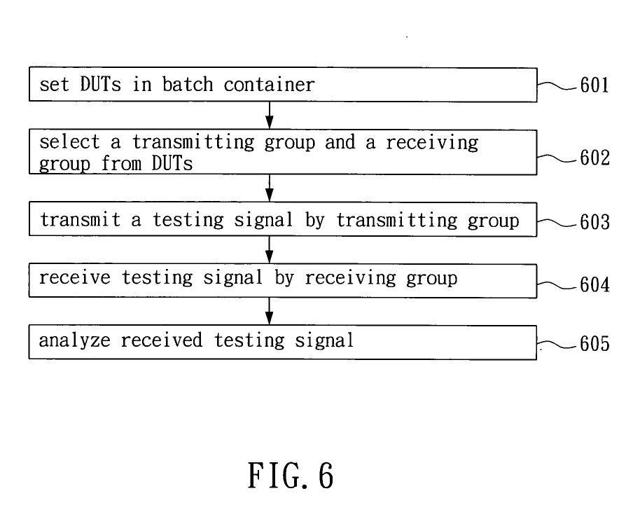

The present invention also provides another preferred embodiment of the batch testing method for measuring the uplink/downlink throughput of DUTs, as shown in FIG. 6. In this embodiment, the DUTs transmit/receive testing signals to/from each other, thus only part of the architecture of FIG. 2 is required to implement this embodiment. More specifically, the signal generator 21, signal monitoring device 22, multiplexer 23 and transceiving unit 241 of the system 20 are not used for this embodiment. As shown in FIG. 6, the flow chart comprises steps of:
601 setting a plurality of DUTs in the batch container 242 of the shielded anechoic chamber 24;
602 selecting a transmitting group and a receiving group of devices from the DUTs by the control unit 25;
603 transmitting a testing signal by the transmitting group of DUTs;
604 receiving the testing signal by the receiving groups of DUTs; and
605 analyzing the received testing signal by the control unit 25.

In the step 603, the testing signal is transmitted in predetermined non-overlapping channels by each DUT of the transmitting group; and in the step 604, the testing signal is received in the non-overlapping channels by each DUT of the receiving group. In the step 605, the control unit 25 analyzes the testing signal received by the DUTS of the receiving group by a proper method, such as performing link quality analysis software, thereby measuring the downlink/uplink throughput of the DUTs of the receiving/transmitting group in the non-overlapping channels.

Taking WLAN products as example again, we can select two DUTs as the transmitting group and another two DUTs as the receiving group. Each DUT of the transmitting/receiving group transmits/receives testing signals in non-overlapping channels, e.g. the first and eighth channels (or the second and ninth channels . . . and so on). In this way, we can measure the downlink/uplink throughput of the DUTs of the receiving/transmitting group in the first and eighth channels. By repeating testing for other channels, we can know the downlink/uplink throughput of the DUTs of the receiving/transmitting group in the whole spectrum specified by the related specification.

While the present invention has been shown and described with reference to the preferred embodiments thereof and in terms of the illustrative drawings, it should not be considered as limited thereby. Various possible modifications and alterations could be conceived of by one skilled in the art to the form and the content of any particular embodiment, without departing from the scope and the spirit of the present invention.

1. A batch testing system for wireless communication devices comprising:
a signal generator for generating a first testing signal;
a transceiving unit, deployed in a shielded anechoic chamber and coupled to the signal generator, for transmitting the first testing signal;
a plurality of wireless communication devices under test (DUTs) in the shielded anechoic chamber for receiving the first testing signal from the transceiving unit and transmitting a, plurality of second testing signals to the transceiving unit; and
a signal monitoring device, coupled to the transceiving unit, for monitoring the second testing signals received by the transceiving unit.

2. The batch testing system of claim 1, further comprising:
a control unit, coupled to the signal generator, the signal monitoring device and the DUTs, for controlling the generation of the first testing signal and the monitoring and transmitting of the second testing signals.

3. The batch testing system of claim 2, further comprising:
a multiplexer, coupled to the control unit, the signal monitoring device and the DUTs, for switching between the signal generator and the signal monitoring unit.

4. The batch testing system of claim 3, wherein the signal generator comprises a plurality of signal-generating units, and the multiplexer switches between the signal-generating units.

5. The batch testing system of claim 3, wherein the signal monitoring device comprises a plurality of signal-monitoring units, and the multiplexer switches between the signal-monitoring units.

6. The batch testing system of claim 1, further comprising:
a batch container for loading the wireless communication devices.

7. The batch testing system of claim 6, wherein the batch container is a rectangular container.

8. The batch testing system of claim 6, wherein the batch container is a circular container.

9. The batch testing system of claim 6, wherein the batch container is set into the shielded anechoic chamber by a window-type loading mechanism.

10. The batch testing system of claim 6, wherein the batch container is set into the shielded anechoic chamber by a drawer-type loading mechanism.

11. The batch testing system of claim 1, wherein the shielded anechoic chamber is pyramidal.

12. The batch testing system of claim 1, wherein the shielded anechoic chamber is cubical.

13. The batch testing system of claim 1, wherein the transceiving unit is an antenna or antenna array.

14. The batch testing system of claim 1, wherein the DUTs are deployed in a quiet zone of the shielded anechoic chamber.

15. The batch testing system of claim 1, wherein the signal generator is a vector signal generator.

16. The batch testing system of claim 1, wherein the signal generator is a Golden Sample of the DUTs.

17. The batch testing system of claim 1, wherein the signal monitoring device comprises a vector signal analyzer and a power meter.

18. The batch testing system of claim 1, wherein the signal monitoring device comprises a spectrum analyzer.

19. The batch testing system of claim 1, wherein the signal monitoring device is a Golden Sample of the DUTs.

20. A batch testing method for wireless communication devices comprising steps of:
setting a plurality of wireless communication devices under test (DUTs) in a shielded anechoic chamber;
generating a first testing signal;
transmitting the first testing signal by a transceiving unit;
receiving the first testing signal by the DUTs;
analyzing the received first testing signal;
transmitting a plurality of second testing signals by the DUTs;
receiving the second testing signals by the transceiving unit; and
monitoring the received second testing signals.

21. The batch testing method of claim 20, wherein the shielded anechoic chamber is pyramidal.

22. The batch testing method of claim 20, wherein the DUTs are deployed in a quiet zone of the shielded anechoic chamber.

23. The batch testing method of claim 20, wherein the first testing signal is generated by a Golden Sample of the DUTs.

24. The batch testing method of claim 20, wherein the first testing signal is generated by a vector signal generator.

25. The batch testing method of claim 20, wherein the DUTs receive the first testing signal in a predetermined channel.

26. The batch testing method of claim 25, wherein the analyzing step comprises:
analyzing minimum input power and packet error rate (PER) of each of the DUTs in the predetermined channel.

27. The batch testing method of claim 20, wherein the received second testing signals are monitored by a Golden Sample of the DUTs.

28. The batch testing method of claim 20, wherein the received second testing signals are monitored by a vector signal analyzer and a power meter.

29. The batch testing method of claim 20, wherein the second testing signals are transmitted in order in a predetermined channel by each of the DUTs.

30. The batch testing method of claim 29, wherein the monitoring step comprises:
analyzing maximum output power and error vector magnitude (EVM) of each of the DUTs in the predetermined channel.

31. The batch testing method of claim 20, wherein the received second testing signals are monitored by a spectrum analyzer.

32. The batch testing method of claim 20, wherein the step of transmitting the second testing signals comprises:
selecting one or more of the DUTs for transmitting the second testing signals in one or more predetermined non-overlapping channels.

33. The batch testing method of claim 32, wherein the monitoring step comprises:
analyzing center frequency and power mask of each of the selected DUTs in a corresponding one of the predetermined channels.

34. The batch testing method of claim 20, wherein the first testing signal is received in a predetermined channel by each of the DUTs in order.

35. The batch testing method of claim 34, wherein the analyzing step comprises:
analyzing downlink throughput of each of the DUTs in the predetermined channel.

36. The batch testing method of claim 29, wherein the monitoring step comprises:
analyzing uplink throughput of each of the DUTs in the predetermined channel.

37. A batch testing method for wireless communication devices comprising:
setting a plurality of wireless communication devices under test (DUTs) in a shielded anechoic chamber;
selecting a transmitting group and a receiving group of DUTs from the plurality of DUTs;
transmitting a testing signal by the transmitting group of DUTs;
receiving the testing signal by the receiving group of DUTs; and
analyzing the testing signal received by the receiving group of DUTs.

38. The batch testing method of claim 37, wherein the testing signal is transmitted in predetermined non-overlapping channels simultaneously by each DUT of the transmitting group.

39. The batch testing method of claim 38, wherein the testing signal is received in the non-overlapping channels simultaneously by each DUT of the receiving group.

40. The batch testing method of claim 39, wherein the analyzing step comprises:
analyzing downlink throughput of the receiving group of DUTs; and
analyzing uplink throughput of the transmitting group of DUTs.
